(19) United States
(12) Patent Application Publication
(10) Pub. No.: US 2008/0124641 A1
(43) Pub. Date: May 29, 2008

(54) Electrophotographic photoreceptor

(75) Inventors: Koichi TORIYAMA, Osaka (JP); Masaki HASHIMOTO, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/984,430

(22) Filed: Nov. 16, 2007

(30) Foreign Application Priority Data
Nov. 28, 2006 (JP) 2006-320239

(51) Int. Cl. G03G 15/08

(52) U.S. Cl. 430/84

(57) ABSTRACT

An electrophotographic photoreceptor, comprising:
an undercoat layer and a photosensitive layer formed in this order on a conductive support,
wherein the undercoat layer contains a titanium oxide [P] consisting of a needle-like titanium oxide [A] and a spherical titanium oxide [B] and a binder resin [R], and
the compounding ratio (by weight) [A]/[B] of the needle-like titanium oxide [A] to the spherical titanium oxide [B] is 60/40 to 90/10.

### CROSS-REFERENCE TO RELATED APPLICATION

This application is related to Japanese Patent Application No. 2006-320239 filed on Nov. 28, 2006, whose priority is claimed under 35 USC §119, the disclosure of which is incorporated by reference in its entirety.

### BACKGROUND OF THE INVENTION

1. Field of the Invention

The present invention relates to an electrophotographic photoreceptor (electrophotographic photoconductor) provided with a conductive support, an undercoat layer and a photosensitive layer. The electrophotographic photoreceptor of the present invention is characterized by the undercoat layer and preferably used for an image formation apparatus that forms an image by a reverse developing process.

2. Description of the Related Art

An electrophotographic process using a photoconductive electrophotographic photoreceptor (hereinafter referred to as “photoreceptor”) involves steps of first charging the surface of the photoreceptor uniformly with electricity by corona discharge in a dark place and carrying out image exposure to allow the exposed portion to selectively discharge, thereby forming an electrostatic image (latent image) on the unexposed portion and then, sticking the colored and charged microparticles (toner) to the latent image by electrostatic attracting force to form a visual image, thereby forming an image.

In such a series of processes, it is demanded for the photoreceptor to have the following fundamental characteristics.

1) It can be uniformly charged up to a proper potential in a dark place.

2) It has high charge-retaining ability and reduced discharge in a dark place.

3) It is superior in light-sensitivity and rapidly discharges by irradiation with light.

It is also demanded for the photoreceptor to have the following characteristics.

4) Charges on its surface are removed easily.

5) It has reduced residual potential.

6) It has mechanical strength and has excellent flexibility.

7) It has stability. Specifically, it is not varied in electric characteristics, particularly chargeability, light-sensitivity and residual potential and the like when it is used repeatedly.

8) It is superior in durability. Specifically, it has resistances to, for example, heat, light, water (moisture) and ozone.

Because recent photoreceptors that have been put into practical use are each provided with a photosensitive layer formed directly on a conductive support, charges are easily injected into the photosensitive layer from the conductive support, so that surface charges disappear or decrease microscopically, and therefore, image defects are easily caused. An attempt is being made to dispose a undercoat layer between the conductive support and the photosensitive layer for the purpose of preventing the image defects and, for example, covering defects on the surface of the conductive support, improving the chargeability, the adhesiveness of the photosensitive layer and coatability.

As conventional materials constituting the undercoat layer, various resins or resins containing metal oxides such as a titanium oxide powder are investigated.

When the undercoat layer is formed by a single layer of a resin, the resin is preferably sparingly soluble in a solvent of a photosensitive layer coating solution. Usually, an alcohol soluble or water soluble resin is used. Specifically, resin materials such as polyethylenes, polypropylenes, polystyrenes, acryl resins, vinyl chloride resins, vinyl acetate resins, polyurethanes, epoxy resins, polyesters, melamine resins, silicon resins, polyvinyl butyrals and polyamides, copolymer resins including two or more repeat units contained in these resin materials, and further, casein, gelatin, polyvinyl alcohols and ethyl cellulose and the like are known. Among these materials, polyamides are particularly preferable (Japanese Unexamined Patent Publications No. SHO 51 (1976)-14132 and No. SHO 52 (1977)-25638). However, photoreceptors provided with an undercoat layer constituted of a single layer of a resin such as a polyamide have increased accumulation of residual potential and therefore have the drawbacks that its sensitivity is deteriorated and fogging of an image is generated. Such a tendency is particularly significant under a low-temperature circumstance.

In order to prevent the generation of image defects and to reduce the accumulation of residual potential, there are proposals of an undercoat layer containing a titanium oxide powder whose surface is not treated (Japanese Unexamined Patent Publication No. SHO 56 (1981)-52757) and an undercoat layer containing a titanium oxide powder coated with alumina or the like to improve dispersibility (Japanese Unexamined Patent Publications No. SHO 59 (1984)-93453 and No. HEI 2 (1990)-181158). Studies have been made as to a method in which a mixture of a titanium oxide powder and a binder resin is used as an undercoat layer wherein the proportion of titanium oxide to be used is optimized to develop a long-life photoreceptor (Japanese Unexamined Patent Publications No. SHO 63 (1988)-234261 and No. SHO 63 (1988)-298251).

In the above prior art technologies, particulate material is used as the titanium oxide powder in the undercoat layer containing the titanium oxide powder.

There is also a proposal of a method using needle-like titanium oxide or nonconductive titanium oxide having a volume resistivity of 10⁵ to 10¹⁰ Ω·cm measured in the form of a pressed powder body (Japanese Unexamined Patent Publications No. HEI 7(1995)-84393 and No. HEI 9(1997)-62021.

However, the prior art technologies have failed to obtain an undercoat layer of a photoreceptor reacting to recent trends to high image quality and high durability.

### SUMMARY OF THE INVENTION

According to the present invention, provided is a photoreceptor comprising an undercoat layer and a photosensitive layer formed in this order on a conductive support, wherein the above undercoat layer contains a titanium oxide [P] consisting of a needle-like titanium oxide [A] and a spherical titanium oxide [B] and a binder resin [R], and the compounding ratio [A]/[B] by weight of the needle-like titanium oxide [A] to the spherical titanium oxide [B] is 60/40 to 90/10.

### BRIEF DESCRIPTION OF THE DRAWINGS

FIG. 1 is a schematic cross-sectional view of a function-separating type photoreceptor according to an embodiment of the present invention;

FIG. 2 is a schematic cross-sectional view of a monolayer-type photoreceptor according to an embodiment of the present invention;

FIG. 3 is a schematic cross-sectional view of a function-separating type photoreceptor provided with a surface protective layer, according to an embodiment of the present invention; and

FIG. 4 is a schematic cross-sectional view of a monolayer-type photoreceptor provided with a surface protective layer, according to an embodiment of the present invention.

### DESCRIPTION OF THE PREFERRED EMBODIMENTS

When a titanium oxide powder is used for an undercoat layer and if the content of the titanium oxide powder is small and the content of a binder resin is large, the volume resistivity of the undercoat layer is increased, the transfer of charges (carriers) created when light is applied is restricted or inhibited, leading to a rise in residual potential, with the result that fogging is easily formed on an image. There is also the problem that repeated use for a long period of time results in a large influence of the accumulation of residual potential and temperature and humidity and this tendency becomes significant particularly at low temperatures, posing a stability problem, so that only insufficient characteristics are obtained.

If the content of the titanium oxide powder is increased, the above problems are lightened. However, repeated use for a long term causes a tendency to accumulate residual potential and this tendency is significant under, particularly a low-humidity circumstance and therefore, the problems concerning long-term stability and environmental characteristics are incompletely solved. Also, when the content of the titanium oxide powder is increased whereas the content of the binder resin is almost zero, the film strength of the undercoat layer and the adhesion between the undercoat layer and the conductive support is reduced. When the photoreceptor is used repeatedly for a long term, there are the problems that the breakdown of the film deteriorates the sensitivity and has an adverse influence on an image and also the volume resistivity of the photoreceptor is sharply dropped, resulting in impaired chargeability.

A titanium oxide powder used in conventional undercoat layers has a particle diameter of 0.01 to 1 μm, an average aspect ratio of 1 to 1.3 when observed by using an electron microscope and a particle form almost similar to a sphere (hereinafter, referred to simply as “granular”) though irregularities are formed on the surface. When such granular titanium oxide is dispersed in the undercoat layer, the contact between particles is close to point contact and therefore the contact area is small. If the content of the titanium oxide powder does not exceed a fixed amount, the resistance of the undercoat layer exhibits a very high value, posing the problem that the characteristics of the photoreceptor, particularly sensitivity and residual potential are impaired.

In the meantime, a needle-like titanium oxide powder has a long and narrow form and therefore, the titanium oxide particles are easily brought into contact with each other to lead to an increase in contact area, and it is expected that the sensitivity and residual potential problems can be more improved than in the case of using granular titanium oxide as the undercoat layer.

However, if needle-like titanium oxide is used for the undercoat layer, there is the problem that repeated use of the photosensitive layer impairs the chargeability of the layer. Though reason therefor has not been clarified, it has been confirmed that this phenomenon occurs particularly significantly under a low-temperature circumstance.

It is an object of the present invention to provide a photoreceptor which has good chargeability, has reduced residual potential, is superior in stability in repeated use and environmental characteristics and is free from image defects such as a moire and fogging.

The present inventors have made earnest studies to solve the above problem and as a result, found that in a photoreceptor provided with an undercoat layer and a photosensitive layer formed in this order on a conductive support, the undercoat layer is made to contain needle-like titanium oxide and granular titanium oxide in a specified ratio, whereby a photoreceptor which has good chargeability, has reduced residual potential, is superior in stability in repeated use and environmental characteristics and is free from image defects such as a moire and fogging can be provided, to complete the present invention.

A photoreceptor according to the present invention comprises an undercoat layer and a photosensitive layer formed in this order on a conductive support, wherein the above undercoat layer contains a titanium oxide [P] consisting of a needle-like titanium oxide [A] and a spherical titanium oxide [B] and a binder resin [R] and the compounding ratio [A]/[B] by weight of the needle-like titanium oxide [A] to the spherical titanium oxide [B] is 60/40 to 90/10.

Specifically, the photoreceptor according to the present invention is provided with an undercoat layer and a photosensitive layer formed in this order on a conductive support and is characterized by the structure of the undercoat layer.

According to the present invention, a photoreceptor can be provided which has good chargeability, has reduced residual potential, is superior in stability in repeated use and environmental characteristics and is free from image defects such as a moire and fogging.

The photoreceptor according to the present invention will be explained in detail with reference to the drawings. The present invention is not limited by these embodiments.

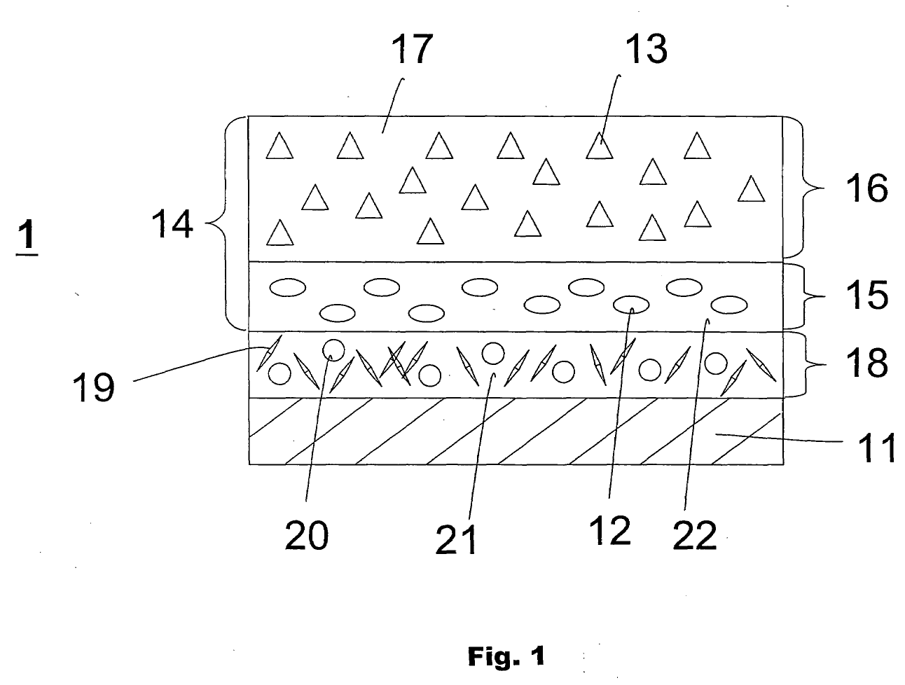

FIG. 1 is a schematic cross-sectional view of a function-separating type photoreceptor according to an embodiment of the present invention.

This photoreceptor 1 has a structure in which an undercoat layer 18 containing a needle-like titanium oxide 19, a spherical titanium oxide 20 and a binder resin A21 is formed on a conductive support 11 and a photosensitive layer 14 consisting of a charge generation layer 15 containing a charge generation material 12 and a binder resin B22 and a charge transport layer 16 containing a charge transport material 13 and a binder resin C17 is laminated on the undercoat layer 18.

The undercoat layer 18 in the present invention contains the titanium oxide [P] consisting of the needle-like titanium oxide 19 [A] and the spherical titanium oxide 20 [B] and a binder resin A21.

The term “needle-like” in the needle-like titanium oxide according to the present invention means a long and narrow form including a bar-like form, columnar form and spindle-like form, and the needle-like titanium oxide usually means those having an aspect ratio of 1.5 or more, the aspect ratio being specifically, a ratio [L]/[S] of the length [L] of the long axis (major axis) to the length [S] of the short axis (minor axis). Therefore, the needle-like titanium oxide unnecessarily has an extremely long and narrow form and also, it is unnecessary that its tip has a sharp edge.

The size of the titanium oxide may be measured by a known method such as a weight sedimentation method or photo-extinction particle size distribution measuring method. However, the aspect ratio of the needle-like titanium oxide is preferably measured directly by an electron microscope.

The average aspect ratio of the needle-like titanium oxide in the present invention is preferably in a range from 1.5 to 300 and particularly preferably in a range from 2 to 10. Even if the aspect ratio exceeds this range, the effect of the needle-form is not different, whereas if the aspect ratio is less than the above range, the effect of the needle-form is scarcely obtained.

Also, in the needle-like titanium oxide in the present invention, it is preferable that the length [L] of the long axis is 100 μm or less and the length [S] of the short axis is 1 μm or less and it is more preferable that the length [L] of the long axis is 20 μm or less and the length [S] of the short axis is 0.5 μm or less.

On the other hand, the primary particle diameter of the spherical titanium oxide in the present invention is preferably 0.05 μm or less and particularly preferably 0.035 μm or less. When the primary particle diameter of the spherical titanium oxide exceeds 0.05 μm, the effect of the spherical titanium oxide on a reduction in the electrification of the photoreceptor is scarcely obtained.

The compounding ratio (by weight) [A]/[B] of the needle-like titanium oxide [A] to the spherical titanium oxide [B] in the titanium oxide [P] in the present invention is preferably 60/40 to 90/10 and particularly preferably 70/30 to 80/20.

If the compounding ratio (by weight) [A]/[B] is in the above range, a photoreceptor can be obtained which has good chargeability, has reduced residual potential, is superior in stability in repeated use and environmental characteristics and is free from image defects such as a moire and fogging.

Since the needle-like titanium oxide has a long and narrow form and therefore, the titanium oxide particles are easily brought into contact with each other to lead to an increase in contact area, it is possible to improve the sensitivity and residual potential. On the other hand, the spherical titanium oxide can improve a reduction in electrification when the photoreceptor is fatigued with repetitive use under a low-humidity environment.

Specifically, the drawback that a use of only the needle-like titanium oxide brings about a reduction in electrification when the photoreceptor is fatigued with repetitive use under a low-humidity environment and a use of only the spherical titanium oxide brings about impaired sensitivity can be removed by using both oxides in a specified compounding ratio.

When the compounding ratio (by weight) [A]/[B] is less than 60/40, the influence of the spherical titanium oxide on the characteristics of the photoreceptor is increased and the sensitivity under a low-humidity environment tends to be impaired, whereas when the compounding ratio [A]/[B] exceeds 90/10, the influence of the needle-like titanium oxide on the characteristics of the photoreceptor is increased and a reduction in electrification tends to be increased when the photoreceptor is fatigued with repetitive use under a low-humidity environment, which makes it difficult to obtain the effect of the blending of the both.

The crystal type of titanium oxide includes an anatase type, rutile type and brucite type. The needle-like titanium oxide of the present invention may be any one of these types or may be a mixture of these types.

In the present invention, the titanium oxide preferably has a high resistance and preferably has a volume resistivity range from 10⁵ to 10¹⁰ Ω·cm when it is a pressed powder body formed by applying a pressure of 100 kg/cm². The volume resistivity of the pressed powder body formed by applying a pressure of 100 kg/cm² is called “powder resistivity”.

When the powder resistivity of the titanium oxide is less than 10⁵ Ω·cm, the resistance as that of the undercoat layer is low, which makes it difficult for the undercoat layer to function as a charge blocking layer. For example, the powder resistivity of the titanium oxide which has been subjected to conductive treatment such as the formation of a tin oxide conductive layer doped with antimony is as very low as 10⁰ to 10¹ Ω·cm. An undercoat layer produced by using the conductive layer does not function as an electric blocking layer and is deteriorated in chargeability as the characteristics of a photoreceptor, with the result that this cannot be used for the photoreceptor. Also, if the powder resistivity of the titanium oxide exceeds 10¹⁰ Ω·cm, that is, if it is equal to or larger than the volume resistivity of the binder resin, the resistivity as that of the undercoat layer is so high that the transfer of charges created when light is applied is restricted or inhibited, bringing about an easy rise in residual potential.

Therefore, as long as the power resistivity of the titanium oxide is kept in the above range, the surface of the needle-like titanium oxide may be untreated or coated with a metal compound such as Al₂O₃, SiO₂ or ZnO or a mixture of these metal compounds to improve dispersibility or surface smoothness. This coating treatment is preferable because this improves the dispersibility or surface smoothness of the titanium oxide. Also, when coating treatment (surface treatment) using methylhydrogen polysiloxane is carried out, the hydrophobic properties of the undercoat layer increase and therefore, a reduction in volume resistivity under a high-temperature and high-humidity circumstance is limited, which is preferable.

Examples of titanium oxide which may be used as the needle-like titanium oxide in the present invention include surface-untreated rutile type titanium oxide (trade name: STR-60N, manufactured by Sakai Chemical Industry Co., Ltd.) and surface untreated rutile type titanium oxide (trade name: FTL-100L, manufactured by Ishihara Sangyo Kaisha, Ltd.).

Examples of titanium oxide which may be used as the spherical titanium oxide in the present invention include surface-untreated rutile type titanium oxide (trade name: TTO-55N, manufactured by Ishihara Sangyo Kaisha, Ltd.), rutile type titanium oxide whose surface is treated with alumina (trade name: TTO-55A, manufactured by Ishihara Sangyo Kaisha, Ltd.) and surface untreated rutile type titanium oxide (trade name: PT-401M, manufactured by Ishihara Sangyo Kaisha, Ltd.).

As the binder resin (binding resin) A21 to be contained in the undercoat layer 18 in the present invention, resins that form the undercoat layer as a monolayer are exemplified. Specific examples of the binder resin A21 include resin materials such as polyethylenes, polypropylenes, polystyrenes, acryl resins, vinyl chloride resins, vinyl acetate resins, polyurethanes, epoxy resins, polyesters, melamine resins, silicon resins, polyvinylbutyral and polyamides, copolymer resins including two or more types of these repeat units, casein, gelatin, polyvinyl alcohol and ethyl cellulose. Among these materials, polyamides are particularly preferable.

It is required for the binder resin A to have the characteristics that it is resistant to dissolution and swelling in the solvent to be used to form the photosensitive layer on the undercoat layer, is superior in adhesion to the conductive support and has flexibility. Polyamides meet these requirements.

Among polyamide type resins, alcohol-soluble polyamides are preferable. Specific examples of such polyamides include copolymer nylons (copolyamides) obtained by binary copolymerization of nylon (polyamide) such as 6-nylon, 66-nylon, 610-nylon, 11-nylon and 12-nylon and types obtained by chemically modifying nylon (polyamide) such as N-alkoxymethyl-modified nylon (polyamide).

Examples of the resin which can be used as the binder resin A in the undercoat layer according to the present invention include a copolymer nylon resin (trade name: CM8000, manufactured by Toray Industries, Inc.), methoxymethylated nylon resin (trade name: EF-30T, manufactured by Nagase ChemteX Corporation) and butyral resin (trade name: 3000K, manufactured by Denki Kagaku Kogyo Kabushiki Kaisha).

The compounding ratio (by weight) [P]/[R] of the titanium oxide [P] to the binder resin [R] in the undercoat layer according to the present invention is preferably 30/70 to 95/5 and particularly preferably 50/50 to 70/30.

When the compounding ratio (by weight) [P]/[R] is less than 30/70, the sensitivity of the photoreceptor is reduced and charges in the undercoat layer are accumulated, leading to an increase in residual potential. This phenomenon is particularly significant under a low-temperature and low-humidity circumstance. Also, when the compounding ratio (by weight) [P]/[R] exceeds 95/5, the storage stability of an undercoat layer coating solution is deteriorated, and therefore the titanium oxide particles are easily precipitated.

Examples of a method of forming the undercoat layer include a method in which titanium oxide is dispersed in a binder resin solution to prepare an undercoat layer coating solution, which is then applied onto a conductive support to form a film. For example, the above titanium oxide and polyamide are dispersed in a mixed solvent of a lower alcohol and an organic solvent, preferably an azeotropic composition solvent, and the obtained undercoat layer coating solution is applied onto the conductive support, followed by drying to form an undercoat layer.

The dispersibilities of the titanium oxide and the binder resin are improved and such a problem as to gelation of the coating solution with time is solved by mixing an organic solvent in a lower alcohol.

As the above lower alcohol, lower alcohols having 1 to 4 carbon atoms are preferable. Examples of these lower alcohols include methyl alcohol, ethyl alcohol, isopropyl alcohol, n-propyl alcohol and n-butyl alcohol. Among these alcohols, methanol is particularly preferable.

Examples of the above organic solvent include cyclic ethers such as 1,3-dioxolan.

Examples of a method of dispersing the undercoat layer coating solution include known methods using a paint shaker, ball mill, sand mill, attritor, oscillation mill or ultrasonic dispersing machine. As dispersion conditions at this time, an appropriate condition under which the contamination with impurities produced by abrasion of materials constituting the container and dispersing machine to be used is avoided may be properly selected taking the physical properties and productivity of the coating film into account.

Also, examples of a method of applying the undercoat layer coating solution include known methods such as a spraying method, bar coating method, roll coating method, blade method, ring method and dipping method. Among these methods, the dipping method is one in which a conductive support is dipped in a coating vessel filled with the coating solution and then pulled up at a constant rate or a sequentially varied rate to thereby form a coating film, and is therefore relatively simple and superior in productivity and cost. Therefore, this method is frequently utilized in the case of producing a photoreceptor. The apparatus to be used in the coating method may be provided with a coating solution dispersing machine such as an ultrasonic generating machine to stabilize the dispersibility of the coating solution.

The film thickness of the undercoat layer is preferably in a range from 0.01 to 10 μm and more preferably in a range from 0.05 to 5 μm. When the film thickness of the undercoat layer is less than 0.01 μm, there is a tendency that the effect of the undercoat layer on the protection from the injection through the substrate is scarcely obtained. When the film thickness of the undercoat layer exceeds 10 μm, there is a tendency that the residual potential is increased, causing a reduction in concentration, making it difficult to stand against actual use.

Next, other structures of the photoreceptor according to the present invention will be explained. The following descriptions are to explain materials, forms and formation methods of general photoreceptors. However, the present invention is not limited by these descriptions.

Examples of the conductive material constituting the conductive support 11 include materials usually used in the fields, for example, metal materials such as aluminum, aluminum alloys, copper, zinc, stainless steel and titanium; composite materials obtained by applying the above metal materials to the surface of a base material by metal foil-laminating treatment or metal vapor deposition treatment and composite materials obtained by applying a conductive polymer or a conductive compound such as tin oxide or indium oxide by vapor deposition or coating. Examples of the base material include high-molecular materials such as polyethylene terephthalate, nylon and polystyrene, hard paper and glass.

The form of the conductive support 11 has a sheet form in the photoreceptor 1 of FIG. 1, but is not limited to this and may be a drum form or an endless belt form.

The surface of the conductive support may be optionally processed by anodic oxidation coating treatment, surface treatment using chemicals or hot water, coloring treatment or irregular reflection treatment such as surface roughing treatment within a range where the image quality is not adversely affected. In an electrophotographic process using a laser as an exposure light source, the wavelengths of laser light are even. Therefore, there is the case where incident laser light interferes with the light reflected in the photoreceptor, resulting in appearance of interference fringes on an image, causing image defects. The above treatments can prevent image defects caused by the interference of laser light.

The photosensitive layer 14 in the present invention is constituted of the charge generation layer 15 containing the charge generation material 12 and the binder resin B22 and the charge transport layer 16 containing the charge transport material 13 and the binder resin C17.

The charge generation layer 15 in the present invention contains the charge generation material 12 that absorbs light to generate charges as its major component.

Examples of materials effective for the charge generation material 12 include those usually used in the fields, for example, azo type pigment such as monoazo type pigments, bisazo type pigments and trisazo type pigments, indigo type pigments such as indigo and thioindigo, perylene type pigments such as perylene imide and perylenic acid anhydride, polycyclic quinone type pigments such as anthraquinone and pyrene quinone, phthalocyanine type pigments such as metal phthalocyanine and nonmetal phthalocyanine, squalilium dyes, pyrylium salts and thiopyrylium salts, triphenylmethane type dyes and inorganic materials such as serene and amorphous silicon. These compounds may be used either alone or in combinations of two or more.

Among these charge generation materials, a particularly preferable material is oxotitanylphthalocyanine which has a high charge generation efficiency and charge injection efficiency, absorbs light to generate a large number of charges and can inject the generated charges into the charge transport material without accumulating them therein.

Also, the charge generation material may be used in combination with sensitizing dyes including triphenylmethane type dyes such as Methyl Violet, Crystal Violet, Night Blue and Victoria Blue, acridine dyes such as Erythrocin, Rhodamine B, Rhodamine 3R, Acridine Orange and Flapeocine, thiazine dyes such as Methylene Blue and Methylene Green, oxazine dyes such as Capri Blue and Meldola's Blue, cyanine dyes, styryl dyes, pyrylium salt dyes or thiopyrylium salt dyes.

Examples of the binder resin (binder resin) B22 include polyester resins, polystyrene resins, polyurethane resins, phenol resins, alkyd resins, melamine resins, epoxy resins, silicone resins, acryl resins, methacryl resins, polycarbonate resins, polyarylate resins, phenoxy resins, polyvinylbutyral reins and polyvinylformal resins and copolymer resins containing two or more types of these repeat units. These resins may be used either alone or in combinations of two or more. Examples of the copolymer resin include insulating resins such as vinyl chloride/vinyl acetate copolymer resins, vinyl chloride/vinyl acetate/maleic acid anhydride copolymer resins and acrylonitrile/styrene copolymer resins.

The compounding ratio (by weight) of the charge generation material and the binder resin B is preferably 10/90 to 99/1. When the compounding ratio (by weight) is less than 10/90, the sensitivity of the photoreceptor tends to deteriorate. Also, when the compounding ratio (by weight) exceeds 99/1, there is a tendency that not only the film strength of the charge generation layer 15 is dropped but also the dispersibility of the charge generation material 12 is deteriorated, so that coarse particles increase, leading to an increase in image defects and particularly, image fogging called black dots which is the phenomenon that the surface charges on a part other than the parts to be removed by exposure are decreased so that a toner is stuck to a white background to form fine black dots.

Examples of a method forming the charge generation layer 15 include a method in which a layer of the charge generation material 12 is formed directly on the undercoat layer 18 by vacuum deposition and a method in which a charge generation layer coating solution obtained by dispersing the charge generation material 12 in a solution of the binder resin B22 is applied to the undercoat layer 18. Generally the latter method is preferable. In the case of forming the charge generation layer 15 by coating, examples of a method of mixing and dispersing the charge generation material in a binder resin solution and a method of applying the coating solution include known methods, for example, the same methods used to form the undercoat layer. Such a dipping coating method is superior in various points as mentioned above and suitable to the formation of the charge generation layer.

Before the charge generation material is dispersed in the binder resin solution, the charge generation material may be milled in advance by using a known milling machine such as a ball mill, sand mill, attritor, oscillation mill and ultrasonic dispersing machine.

Examples of the solvent to be used for the charge generation layer coating solution include hydrocarbon halides such as dichloromethane and dichloroethane, ketones such as acetone, methyl ethyl ketone and cyclohexanone, esters such as ethyl acetate and butyl acetate, ethers such as tetrahydrofuran (THF) and dioxane, alkyl ethers of ethylene glycol such as 1,2-dimethoxyethane, aromatic hydrocarbons such as benzene, toluene and xylene or aprotic polar solvents such as N,N-dimethylformamide and N,N-dimethylacetamide. These compounds may be used either alone or in combinations of two or more. In consideration of a global environment, it is preferable to use a non-halogen solvent.

The film thickness of the charge generation layer 15 is preferably in a range from 0.05 to 5 μm and more preferably in a range from 0.1 to 1 μm. When the film thickness of the charge generation layer 15 is less than 0.05 μm, there is a tendency that the light absorbing efficiency of the photoreceptor is reduced and the sensitivity is easily reduced. When the film thickness of the charge generation layer 15 exceeds 5 μm, the transfer of charges in the charge generation layer is a rate-determining step in a process of removing charges on the surface of the photoreceptor and the sensitivity tends to deteriorate.

The charge transport layer 16 in the present invention contains, as its major component, the charge transport material 13 which receives and transfers the charges generated in the charge generation material 12.

Examples of materials effective as the charge transport material 13 include those usually used in the fields, for example, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives and benzidine derivatives, polymers having groups derived from these compounds on the main chain or side chain, for example, poly-N-vinylcarbazole and poly-1-vinylpyrene and poly-9-vinylanthracene. These compounds may be used either alone or in combinations of two or more.

Any binder resin may be used as the binder resin (binding resin) C17 without any particular limitation insofar as it is highly compatible with the charge transport material 13. Examples of the binder resin C17 include polymethylmethacrylate resins, polystyrene resins, vinylpolymer resins such as polyvinyl chloride resins and their copolymer resins, polycarbonate resins, polyester resins, polyester carbonate resins, polysulfone resins, phenoxy resins, epoxy resins, silicone resins, polyarylate resins, polyamide resins, polyether resins, polyurethane resins, polyacrylamide resins and phenol resins, and heatcurable resins obtained by partially crosslinking these resins. These resins may be used either alone or in combinations of two or more. Among these materials, polystyrene resins, polycarbonate resins, polyarylate resins and polyphenylene oxide are particularly preferable because these compounds have a volume resistivity of 10¹³Ω or more, and are superior in electric insulation and also in coatability and potential characteristics.

The compounding ratio (by weight) of the charge transport material to the binder resin C is preferably 25/75 to 45/55. When the compounding ratio (by weight) is less than 25/75, the viscosity of the coating solution increases, and this causes a reduction in coating speed and brings about significantly low productivity, in the case of forming the charge transport layer 16 by a dipping coating method. In view of this situation, if the amount of a solvent in the coating solution is increased to restrict an increase in the viscosity of the coating solution, there is a tendency that a brushing phenomenon occurs and the formed charge transport layer 16 is made cloudy. When the compounding ratio (by weight) exceeds 45/55, there is a tendency that printing durability is more reduced than in the case where the value of the binder resin C is high, bringing about an increase in the abrasion of the photosensitive layer.

The charge transport layer 16 may optionally contain additives such as a plasticizer and leveling agent to improve coatability, flexibility and surface smoothness. Examples of the plasticizer include dibasic acid ester, aliphatic acid ester, phosphate, phthalate, chloroparaffin or epoxy type plasticizers. Examples of the leveling agent include silicone type leveling agents.

Also, the charge transport layer 16 may optionally contain microparticles of inorganic compounds or organic compounds to improve mechanical strength and electric characteristics.

Examples of a method of forming the charge transport layer 16 include a method in which a charge transport layer coating solution obtained by dispersing the charge transport material 13 and optionally the additives in a solution of the binder resin C17 is applied onto the charge generation layer 15. Examples of a method of mixing and dispersing the charge transport material in a binder resin solution and a method of applying the coating solution include known methods, for example, the same methods used to form the undercoat layer or the charge generation layer. Such a dipping coating method is superior in various points as mentioned above and suitable to the formation of the charge transport layer.

Examples of the solvent to be used for the charge transport layer coating solution include hydrocarbon halides such as dichloromethane and dichloroethane, ketones such as acetone, methyl ethyl ketone and cyclohexanone, esters such as ethyl acetate and butyl acetate, ethers such as tetrahydrofuran (THF) and dimethoxymethyl ether dioxane, alkyl ethers of ethylene glycol such as 1,2-dimethoxyethane, aromatic hydrocarbons such as benzene, toluene, xylene and monochlorobenzene or aprotic polar solvents such as N,N-dimethylformamide and N,N-dimethylacetamide. These compounds may be used either alone or in combinations of two or more. In consideration of a global environment, it is preferable to use a non-halogen solvent. Solvents such as alcohols, acetonitrile or methyl ethyl ketone may be optionally added to these solvents.

The film thickness of the charge transport layer 16 is preferably in a range from 5 to 50 μm and more preferably in a range from 10 to 40 μm. When the film thickness of the charge transport layer 16 is less than 5 μm, the charge retention ability of the surface of the photoreceptor tends to be deteriorated. Also, when the film thickness of the charge transport layer 16 exceeds 50 μm, the resolution of the photoreceptor tends to be dropped.

At least one or more electron accepting materials or dyes may be added in the photosensitive layer for the purpose of improving the sensitivity of the photoreceptor and reducing residual potential and fatigues in repeated use.

Examples of the electron accepting material include acid anhydrides such as succinic acid anhydride, maleic acid anhydride, phthalic acid anhydride and 4-chloronaphthalic acid anhydride, quinone type compounds such as parabenzoquinone, chloranil, tetrachloro-1,2-benzoquinone, hydroquinone, 2,6-dimethylbenzoquinone, methyl-1,4-benzoquinone, α-naphthoquinone and β-naphthoquinone, anthraquinones such as anthraquinone and 1-nitroanthraquinone, aldehydes such as 4-nitrobenzaldehyde, polycyclic or heterocyclic nitro compounds such as 2,4,7-trinitro-9-fluorenone, 1,3,6,8-tetranitrocarbazole, p-nitrobenzophenone, 2,4,5,7-tetranitro-9-fluorenone and 2-nitrofluorenone, cyano compounds such as tetracyanoethylene, terephthalmalondinitrile, 7,7,8,8-tetracyanoquinodimethane, 4-(p-nitrobenzoyloxy)-2′,2′-dicyanovinylbenzene and 4-(m-nitrobenzoyloxy)-2′,2′-dicyanovinylbenzene and electron attractive materials such as diphenoquinone compounds and compounds obtained by polymerizing these electron attractive materials. Among these materials, fluorenone type compounds, quinone type compounds and benzene derivatives having electron attractive substituents such as Cl, CN and NO₂ are particularly preferable.

Examples of the dye include xanthene type dyes, thiazine dyes, triphenylmethane dyes, quinoline type pigments and organic photoconductive compounds which function as an optical sensitizer such as copper phthalocyanine.

Also, in the photosensitive layer, ultraviolet absorbers and antioxidants such as benzoic acid, stilbene compounds or their derivatives, and nitrogen-containing compounds such as triazole compounds, imidazole compounds, oxadiazole compounds and thiazole compounds or their derivatives may be added.

Thus, the function separating type photoreceptor according to the present invention is obtained. In this case, the photoreceptor according to the present invention may be a monolayer type photoreceptor provided with a photosensitive layer containing both the charge generation material 12 and the charge transport material 13.

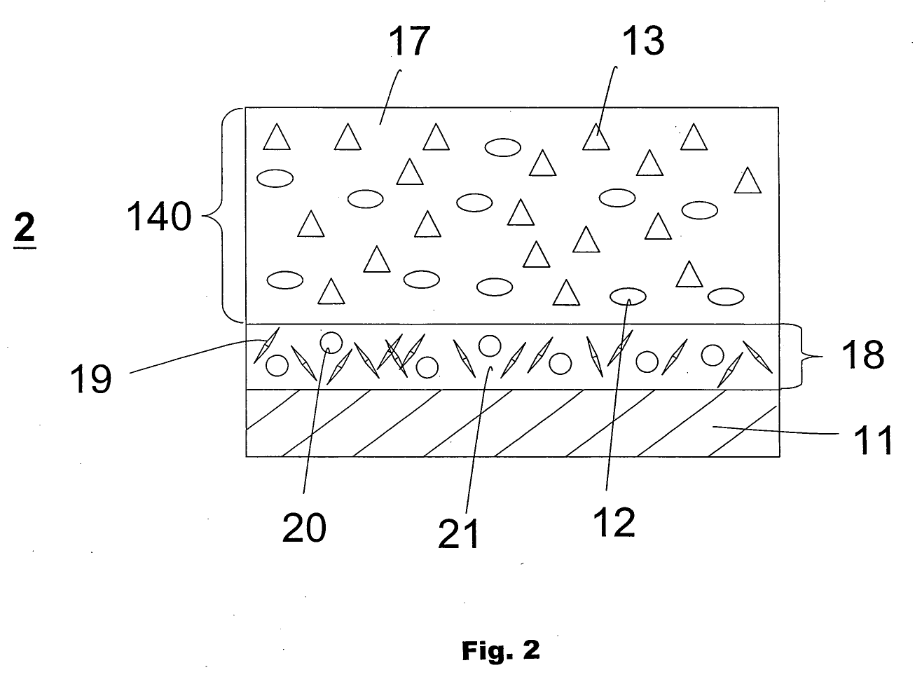

FIG. 2 is a schematic cross-sectional view of a monolayer type photoreceptor in an embodiment of the present invention. The photoreceptor 2 has a structure in which an undercoat layer 18 containing a needle-like titanium oxide 19, a spherical titanium oxide 20 and a binder resin A21 is formed on a conductive support 11 and a photosensitive layer 140 containing a charge generation material 12, a charge transport material 13 and a binder resin C17 is laminated on the undercoat layer 18.

The structural material of the photosensitive layer 140 and a method of forming the photosensitive layer 140 are the same as those of the undercoat layer or photosensitive layer of the function separating type photoreceptor.

The film thickness of the photosensitive layer in this case is preferably in a range from 5 to 100 μm and more preferably in a range from 10 to 50 μm. When the film thickness of the photosensitive layer is less than 5 μm, the charge retention ability of the surface of the photoreceptor tends to deteriorate. When the film thickness of the photosensitive layer exceeds 100 μm, the productivity of the photoreceptor tends to drop.

Also, the photoreceptor of the present invention may be provided with a surface protective layer 150 for the purpose of protecting the surface thereof.

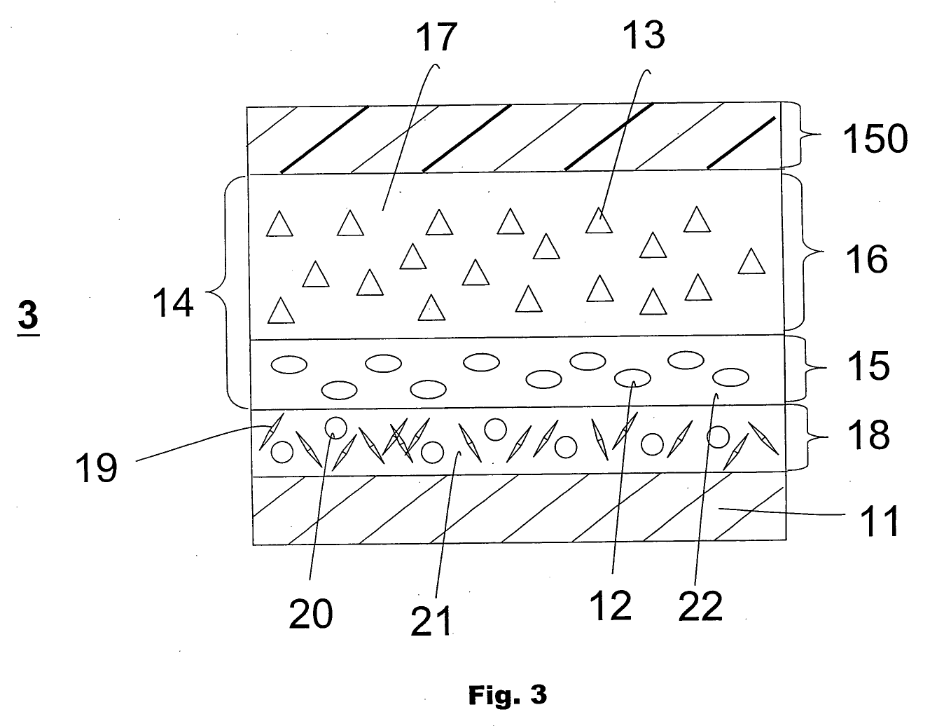

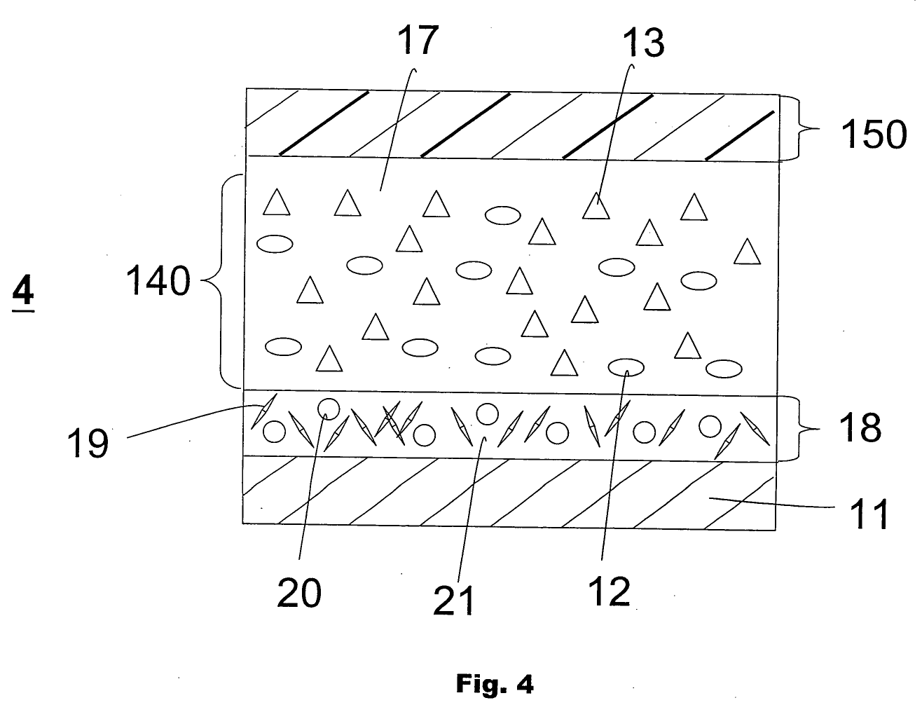

FIGS. 3 and 4 are schematic cross-sectional views of a functional separating type and a monolayer type photoreceptor provided with a surface protective layer respectively in embodiments according to the present invention. Specifically, the surface protective layer 150 is formed on the charge generation layer 16 of the functional separating type photoreceptor shown in FIG. 1 in the former photoreceptor 3 and on the photosensitive layer 140 of the monolayer type photoreceptor shown in FIG. 2 in the latter photoreceptor 4. The basic structures of these photoreceptors are the same as those of the photoreceptors of FIGS. 1 and 2.

Examples of resins effective for the surface protective layer 150 include those usually used in the fields, for example, polystyrenes, polyacetals, polyethylenes, polycarbonates, polyarylates, polysulfones, polypropylenes and polyvinyl chlorides. These resins may be used either alone or in combinations of two or more. Among these materials, polycarbonates and polyarylates superior in abrasion resistance and electric characteristics are particularly preferable.

A filler material may be optionally added to the surface protective layer 150 to improve abrasion resistance.

Examples of the filler material include organic filler materials, for example, a fluororesin powder such as polytetrafluoroethylene, silicone resin powder and a-carbon powder and inorganic fillers of inorganic materials, for example, powders of metals such as copper, tin, aluminum and indium, metal oxides such as silica, tin oxide, zinc oxide, titanium oxide, indium oxide, antimony oxide, bismuth oxide, tin oxide doped with antimony and indium oxide doped with tin and potassium titanate. These materials may be used either alone or in combinations of two or more. Among these materials, inorganic materials are particularly preferable from the viewpoint of the hardness of the filler.

The filler material may be surface-treated (water-repellent treatment) with an organic material or inorganic material to improve its dispersibility in a resin. Examples of the organic material include silane coupling agents, fluorine type silane coupling agents and high fatty acids. Examples of the inorganic material include alumina, zirconia, tin oxide and silica.

The average primary particle diameter of the filler is preferably 0.01 to 0.5 μm from the viewpoint of the light-transmittance of the surface protective layer and abrasion resistance.

Generally, the concentration of the filler material in the surface protective layer is preferably 50% by weight or less and particularly preferably 30% by weight or less based on the total solid of the surface protective layer. The abrasion resistance is more improved with an increase in the concentration of the filler material. However, in the case where the concentration of the filler is too high, there is a tendency that this brings about a rise in residual potential and the writing light transmittance of the surface protective layer is therefore easily dropped.

The surface protective layer may contain a charge transport material such as those mentioned above, ultraviolet preventive, antioxidant, inorganic materials such as metal oxides, organic metal compounds and electron accepting materials.

Also, the surface protective layer may be optionally mixed with a plasticizer such as a dibasic acid ester, fatty acid ester, phosphate, phthalate and chlorinated paraffin to make such an improvement in mechanical properties as to impart processability and flexibility or may be blended with a leveling agent such as a silicon resin.

The surface protective layer may be formed by a known method. The film thickness of the surface protective layer is preferably 0.1 to 10 μm and more preferably 1 to 8 μm.

The photoreceptor used repeatedly for a long term preferably has high mechanical durability and is resistant to abrasion. However, in an actual machine, ozone, NOₓ gas and the like are generated from, for example, charged members and adhere to the surface of the photoreceptor, causing image flow. In order to prevent this, it is necessary to abrade the photosensitive layer at a rate more than a certain level. Therefore, the film thickness of the surface protective layer is preferably in the above range in consideration of long-term repeated use of the photoreceptor. In the case where the film thickness of the surface protective layer exceeds 8 μm, there is a tendency that the residual potential is increased and reproducibility of fine dots is easily deteriorated.

The photoreceptor according to the present invention is preferably used for an image forming apparatus that forms an image by a reverse developing process.

According to such an image formation apparatus, an image having excellent characteristics free from image defects can be formed. In the case of using the image formation apparatus continuously under, particularly, lower humidity, an image free from image defects such as fogging can also be formed. Therefore, such an image formation apparatus may be combined with other image processing apparatuses, facsimiles, printers and the like.

### EXAMPLES

The present invention will be explained in detail by way of examples and comparative examples, which are, however, not intended to be limiting of the present invention.

In each of these examples and comparative examples, a function separating type photoreceptor as shown in FIG. 1 was produced and the obtained photoreceptor was evaluated. However, the present invention is not limited to this type and the same effect is obtained even if a monolayer type structure is used.

FIG. 1 is a schematic cross-sectional view of a function-separating type photoreceptor 1 according to an embodiment of the present invention. This photoreceptor 1 has a structure in which an undercoat layer 18 containing a needle-like titanium oxide 19, a spherical titanium oxide 20 and a binder resin A21 is formed on a conductive support 11 and a photosensitive layer 14 including a charge generation layer 15 containing a charge generation material 12 and a binder resin B22 and a charge transport layer 16 containing a charge transport material 13 and a binder resin C17 is laminated on the undercoat layer 18.

### Example 1

7 parts by weight of titanium oxide (trade name: STR-60N, manufactured by Sakai Chemical Industry Co., Ltd.) with the surface being untreated, which had a powder resistance of about 9×10⁵ Ω·cm, a long axis length L of 0.05 μm, a short axis length S of 0.01 μm and an aspect ratio of 5 were used as the needle-like titanium oxide 19[A]. 3 parts by weight of titanium oxide [P] (trade name: TTQ-55N, manufactured by Ishihara Sangyo Kaisha Ltd.) with the surface being untreated, which had a powder resistance of about 4.9×10⁵ Ω·cm and a primary particle diameter of 0.03 μm were used as the spherical titanium oxide 20[B]. 10 parts by weight of a copolymer-nylon resin (trade name: CM8000, manufactured by Toray Industries Inc.) were used as the binder resin A21[R]. The above components 19[A], 20[B] and A21[R] were added to and mixed with a mixture solvent of 108 parts by weight of methyl alcohol and 72 parts by weight of 1,3-dioxolan. The mixture was dispersed by a paint shaker for 8 hours to prepare an undercoat layer coating solution.

Then, the obtained undercoat layer coating solution was filled in a coating vessel (120 mm (inside diameter)×400 mm (height)) and a 80-mm-diameter and 348-mm-long drum-shaped conductive support made of aluminum as the conductive support 11 was dipped in the coating solution, then pulled up gradually and subjected to air drying to obtain an undercoat layer 18 having a film thickness of 1 μm.

Next, 2 parts by weight of an oxotitanyl phthalate cyanine crystal which was a crystal type showing a clear peak at a Bragg angle (2θ±0.2°) of 27.2° in an X-ray diffraction spectrum measured by Cu—Kα character X-rays (wavelength: 1.54 Å) as the charge generation material 12, 1 part by weight of a butyral resin (trade name: S-LEC BM-2, manufactured by Sekisui Chemical Co., Ltd.) as the binder resin B22 and 97 parts by weight of methyl ethyl ketone were mixed and dispersed by a paint shaker for 5 hours to prepare a charge generation layer coating solution.

Then, the obtained charge generation layer coating solution was applied to the undercoat layer 18 by the same dipping coating method as in the case of the undercoat layer 18 and subjected to air drying to obtain a charge generation layer 15 having a film thickness of 0.41 μm.

5.0 parts by weight of the following compound as the charge transport material 13 and 8.0 parts by weight of a polycarbonate resin (trade name: TS2050, manufactured by Teijin Chemicals Ltd.) as the binder resin 17 were mixed and dissolved in a solvent constituted of 47 parts by weight of tetrahydrofuran, to prepare a charge transport layer coating solution.

Then, the obtained charge transport layer coating solution was applied to the charge generation layer 15 by the same dipping coating method as in the case of the undercoat layer 18 and the coating film was dried by 120° C. hot air for one hour to obtain a charge transport layer 16 having a film thickness of 24 μm, thereby completing a function separating type photoreceptor as shown in FIG. 1.

The photoreceptor manufactured in the above manner was mounted on a test copying machine (trade name: AR-625S, manufactured by Sharp Kabushiki kaisya, digital copying machine) to measure the surface potential of the photoreceptor at the developing section, specifically the surface potential V0 of the photoreceptor in the dark excluding the exposure process to observe the chargeability of the photoreceptor and the surface potential VL of the photoreceptor at the black ground portion when the photoreceptor was exposed to observe the sensitivity thereof. In these measurements, the developing unit was removed from the test copying machine and a surface potentiometer (trade name: MODEL 344, manufactured by Treck Japan kk) was installed on the developing portion instead of the developing unit. These characteristics of the photoreceptor were measured in the initial stage and after the operation was repeated 100,000 times (after 100,000-time-fatigue test) in the following two conditions: 5° C./10% RH, that is, low temperature/low humidity (hereinafter abbreviated as “L/L”) circumstance and 25° C./60% RH, that is, normal temperature/normal humidity (hereinafter abbreviated as “N/N”) circumstance.

The type, dimension, physical properties and compounding ratio of the titanium oxide [P] constituted of the needle-like titanium oxide [A] and the spherical titanium oxide [B] and binder resin [R] are shown in Table 1 and the obtained results are shown in Table 2.

Also, the undercoat layer coating solution was allowed to stand at ambient temperature for one week to confirm the state of the coating solution (precipitation, gelation). The results are shown in Table 2.

Moreover, in the L/L circumstance, the fogging and image density of the photoreceptor were evaluated by the following measurement method and evaluation method to carry out the overall evaluation of the photoreceptor. The obtained results are shown in Table 2.

### [Fogging]

The amount Wk of fogging on a white solid image was measured by using a COLOR MEASURING SYSTEM (trade name: Z-Σ90, manufactured by Nippon Denshoku Industries Co., Ltd.) in the initial stage and after the operation was repeated 100,000 times (after 100,000 sheets were printed) to carry out the evaluation.

By using the above device, three excitation values X, Y and Z were found and the value of Z was defined as the amount of fogging of the formed image. The result was determined according to the following standard.

⊚: Good (Z is less than 0.5)

◯: No problem in practical use (Z is 0.5 or more and less than 0.8)

X: Unpracticable (Z is 0.8 or more)

### [Image Density]

The reflection density of a black solid image was measured by using a Machbes Reflection Densitometer (trade name: Machbes RD918, manufactured by Sakata Inx Corporation) in the initial stage and after the operation was repeated 100,000 times (after 100,000 sheets were printed) to evaluate the image density.

The image density was determined according to the following standard.

⊚: Good (image density: 1.4 or more)

◯: No problem in practical use (image density is 1.25 or more and less than 1.4)

X: Unpracticable (image density: less than 1.25)

### [Overall Determination]

The results of the fogging and image density were determined overall according to the following standard.

⊚: Good (the determinations of fogging and image density are all ⊚)

◯: No problem in practical use (the determinations of fogging and image density are ⊚ or ◯)

X: Unpracticable (one of the determinations of the fogging and image density is x)

### Example 2

A photoreceptor was manufactured in the same manner as in Example 1 except that the amount of STR-60N was changed to 9 parts by weight instead of 7 parts by weight as the needle-like titanium oxide [A] and the amount of TTO-55N was changed to 1 part by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 3

A photoreceptor was manufactured in the same manner as in Example 1 except that the amount of STR-60N was changed to 6 parts by weight instead of 7 parts by weight as the needle-like titanium oxide [A] and the amount of TTO-55N was changed to 4 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 4

A photoreceptor was manufactured in the same manner as in Example 1 except that titanium oxide (trade name: FTL-100L, manufactured by Ishihara Sangyo Kaisha Ltd.) with the surface being untreated, which had a powder resistance of about 3×10⁵ Ω·cm, a long axis length L of 1.68 μm, a short axis length S of 0.13 μm and an aspect ratio of 13 was used in place of STR-60N as the needle-like titanium oxide [A] and titanium oxide (trade name: TTO-55A, manufactured by Ishihara Sangyo Kaisha Ltd.) with the surface being treated with alumina, which had a powder resistance of about 4.2×10⁷ Ω·cm and a primary particle diameter of 0.031 μm was used in place of TTO-55N as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 5

A photoreceptor was manufactured in the same manner as in Example 4 except that the amount of FTL-100L was changed to 9 parts by weight instead of 7 parts by weight as the needle-like titanium oxide [A] and the amount of TTO-55A was changed to 1 part by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 6

A photoreceptor was manufactured in the same manner as in Example 4 except that the amount of FTL-100L was changed to 6 parts by weight instead of 7 parts by weight as the needle-like titanium oxide [A] and the amount of TTO-55A was changed to 4 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 7

A photoreceptor was manufactured in the same manner as in Example 1 except that the amount of STR-60N was changed to 4.2 parts by weight instead of 7 parts by weight as the needle-like titanium oxide [A], the amount of TTO-55N was changed to 1.8 parts by weight instead of 3 parts by weight as the spherical titanium oxide [B] and the amount of CM8000 was changed to 14 parts by weight instead of 10 parts by weight as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 8

A photoreceptor was manufactured in the same manner as in Example 1 except that the amount of STR-60N was changed to 13.3 parts by weight instead of 7 parts by weight as the needle-like titanium oxide [A], the amount of TTO-55N was changed to 5.7 parts by weight instead of 3 parts by weight as the spherical titanium oxide [B] and the amount of CM8000 was changed to 1 part by weight instead of 10 parts by weight as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 9

A photoreceptor was manufactured in the same manner as in Example 1 except that a methoxymethylated nylon resin (trade name EF-30T, manufactured by Nagase ChemteX Corporation) was used in place of CM8000 as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 1

A photoreceptor was manufactured in the same manner as in Example 1 except that the amount of STR-60N was changed to 10 parts by weight instead of 7 parts by weight as the needle-like titanium oxide [A] and TTO-55N was not used as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 2

A photoreceptor was manufactured in the same manner as in Example 1 except that STR-60N was not used as the needle-like titanium oxide [A] and the amount of TTO-55N was changed to 10 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 3

A photoreceptor was manufactured in the same manner as in Example 1 except that the amount of STR-60N was changed to 9.5 parts by weight instead of 7 parts by weight as the needle-like titanium oxide [A] and the amount of TTO-55N was changed to 0.5 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 4

A photoreceptor was manufactured in the same manner as in Example 1 except that the amount of STR-60N was changed to 5 parts by weight instead of 7 parts by weight as the needle-like titanium oxide [A] and the amount of TTO-55N was changed to 5 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 5

A photoreceptor was manufactured in the same manner as in Example 4 except that the amount of FTL-100L was changed to 9.5 parts by weight instead of 7 parts by weight as the needle-like titanium oxide [A] and the amount of TTO-55A was changed to 0.5 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Comparative Example 6

A photoreceptor was manufactured in the same manner as in Example 4 except that the amount of FTL-100L was changed to 5 parts by weight instead of 7 parts by weight as the needle-like titanium oxide [A] and the amount of TTO-55A was changed to 5 parts by weight instead of 3 parts by weight as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 10

A photoreceptor was manufactured in the same manner as in Example 1 except that titanium oxide (trade name: PT-401M, rutile type, manufactured by Ishihara Sangyo Kaisha Ltd.) with the surface being untreated, which had a powder resistance of about 6×10⁵ Ω·cm and a primary particle diameter of 0.07 μm was used in place of TTO-55N as the spherical titanium oxide [B] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 11

A photoreceptor was manufactured in the same manner as in Example 1 except that the amount of STR-60N was changed to 3.5 parts by weight instead of 7 parts by weight as the needle-like titanium oxide [A], the amount of TTO-55N was changed to 1.5 parts by weight instead of 3 parts by weight as the spherical titanium oxide [B] and the amount of CM8000 was changed to 15 parts by weight instead of 10 parts by weight as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 12

A photoreceptor was manufactured in the same manner as in Example 1 except that the amount of STR-60N was changed to 13.9 parts by weight instead of 7 parts by weight as the needle-like titanium oxide [A], the amount of TTO-55N was changed to 5.9 parts by weight instead of 3 parts by weight as the spherical titanium oxide [B] and the amount of CM8000 was changed to 0.2 parts by weight instead of 10 parts by weight as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

### Example 13

A photoreceptor was manufactured in the same manner as in Example 1 except that a butyral resin (trade name: 3000K, manufactured by Denki Kagaku Kogyo Kabushiki Kaisha) was used in place of CM8000 as the binder resin A[R] and evaluated.

The type, dimension, physical properties and compounding ratio of the titanium oxide [P] constituted of the needle-like titanium oxide [A] and the spherical titanium oxide [B], and binder resin [R] are shown in Table 1 and the obtained results are shown in Table 2.

TABLE 1

| | Titanium Oxide [P] | | | | | | | | | | | Binder | |
|---|---|---|---|---|---|---|---|---|---|---|---|---|---|
| | Needle-like Titanium Oxide [A] | | | | | | Spherical Titanium Oxide [B] | | | | | Resin | |
| | | Long | Short | | | | | Primary | | | Com- | [R] | Com- |
| | Type | Axis | Axis | Aspect | Powder | Surface | Type | Particle | Powder | Surface | pounding | Type | pounding |
| | (model | [L] | [S] | Ratio | Resistance | Treat- | (model | Diameter | Resistance | Treat- | Ratio | (model | Ratio |
| | number) | (μm) | (μm) | [L]/[S] | (Ω · cm) | ment | number) | (μm) | (Ω · cm) | ment | [A]/[B] | number) | [P]/[R] |
| Ex. 1 | STR-60N | 0.05 | 0.01 | 5 | 9 × 10⁵ | non | TTO-55N | 0.03 | 4.9 × 10⁵ | non | 70/30 | CM8000 | 50/50 |
| Ex. 2 | STR-60N | 0.05 | 0.01 | 5 | 9 × 10⁵ | non | TTO-55N | 0.03 | 4.9 × 10⁵ | non | 90/10 | CM8000 | 50/50 |
| Ex. 3 | STR-60N | 0.05 | 0.01 | 5 | 9 × 10⁵ | non | TTO-55N | 0.03 | 4.9 × 10⁵ | non | 60/40 | CM8000 | 50/50 |
| Ex. 4 | FTL-100L | 1.68 | 0.13 | 13 | 3 × 10⁵ | non | TTO-55A | 0.03 | 4.2 × 10⁷ | Al₂O₃ | 70/30 | CM8000 | 50/50 |
| Ex. 5 | FTL-100L | 1.68 | 0.13 | 13 | 3 × 10⁵ | non | TTO-55A | 0.03 | 4.2 × 10⁷ | Al₂O₃ | 90/10 | CM8000 | 50/50 |
| Ex. 6 | FTL-100L | 1.68 | 0.13 | 13 | 3 × 10⁵ | non | TTO-55A | 0.03 | 4.2 × 10⁷ | Al₂O₃ | 60/40 | CM8000 | 50/50 |
| Ex. 7 | STR-60N | 0.05 | 0.01 | 5 | 9 × 10⁵ | non | TTO-55N | 0.03 | 4.9 × 10⁵ | non | 70/30 | CM8000 | 30/70 |
| Ex. 8 | STR-60N | 0.05 | 0.01 | 5 | 9 × 10⁵ | non | TTO-55N | 0.03 | 4.9 × 10⁵ | non | 70/30 | CM8000 | 95/5 |
| Ex. 9 | STR-60N | 0.05 | 0.01 | 5 | 9 × 10⁵ | non | TTO-55N | 0.03 | 4.9 × 10⁵ | non | 70/30 | EF-30T | 50/50 |
| Co. Ex. 1 | STR-60N | 0.05 | 0.01 | 5 | 9 × 10⁵ | non | — | — | — | — | 100/0 | CM8000 | 50/50 |
| Co. Ex. 2 | — | — | — | — | — | — | TTO-55N | 0.03 | 4.9 × 10⁵ | non | 0/100 | CM8000 | 50/50 |
| Co. Ex. 3 | STR-60N | 0.05 | 0.01 | 5 | 9 × 10⁵ | non | TTO-55N | 0.03 | 4.9 × 10⁵ | non | 95/5 | CM8000 | 50/50 |
| Co. Ex. 4 | STR-60N | 0.05 | 0.01 | 5 | 9 × 10⁵ | non | TTO-55N | 0.03 | 4.9 × 10⁵ | non | 50/50 | CM8000 | 50/50 |
| Co. Ex. 5 | FTL-100L | 1.68 | 0.13 | 13 | 3 × 10⁵ | non | TTO-55A | 0.03 | 4.2 × 10⁷ | non | 95/5 | CM8000 | 50/50 |
| Co. Ex. 6 | FTL-100L | 1.68 | 0.13 | 13 | 3 × 10⁵ | non | TTO-55A | 0.03 | 4.2 × 10⁷ | non | 50/50 | CM8000 | 50/50 |
| Ex. 10 | STR-60N | 0.05 | 0.01 | 5 | 9 × 10⁵ | non | PT-401M | 0.07 | 6 × 10⁵ | non | 70/30 | CM8000 | 50/50 |
| Ex. 11 | STR-60N | 0.05 | 0.01 | 5 | 9 × 10⁵ | non | TTO-55N | 0.03 | 4.9 × 10⁵ | non | 70/30 | CM8000 | 25/75 |
| Ex. 12 | STR-60N | 0.05 | 0.01 | 5 | 9 × 10⁵ | non | TTO-55N | 0.03 | 4.9 × 10⁵ | non | 70/30 | CM8000 | 99/1 |
| Ex. 13 | STR-60N | 0.05 | 0.01 | 5 | 9 × 10⁵ | non | TTO-55N | 0.03 | 4.9 × 10⁵ | non | 70/30 | 3000K | 50/50 |

Ex.: Example, Co. Ex.: Comparative Example

TABLE 2

| | Surface Potential | | | | | | | | | Image Determination | | | | |
|---|---|---|---|---|---|---|---|---|---|---|---|---|---|---|
| | Normal Temp./Normal | | | | | | | | | Low Temp./Low Humidity | | | | |
| | Humidity | | | | Low Temp./Low Humidity | | | | | (L/L) | | | | |
| | (N/N) | | | | (L/L) | | | | | | | After | | |
| | | | After | | | | After | | State of | | | 100,000-time- | | |
| | | | 100,000-time- | | | | 100,000-time- | | Coating | | | fatigue Test | | |
| | Initial Stage | | fatigue Test | | Initial Stage | | fatigue Test | | Solution | Initial Stage | | (-V) | | |
| | (-V) | | (-V) | | (-V) | | (-V) | | after one | | Image | | Image | Overall |
| | V0 | VL | V0 | VL | V0 | VL | V0 | VL | week | Fogging | Density | Fogging | Density | Determination |
| Ex. 1 | 650 | 65 | 645 | 66 | 655 | 145 | 652 | 138 | no change | ⊚ | ⊚ | ⊚ | ⊚ | ⊚ |
| Ex. 2 | 645 | 62 | 642 | 64 | 648 | 125 | 638 | 119 | no change | ⊚ | ⊚ | ⊚ | ⊚ | ⊚ |
| Ex. 3 | 652 | 66 | 650 | 66 | 654 | 150 | 660 | 153 | no change | ⊚ | ⊚ | ⊚ | ⊚ | ⊚ |
| Ex. 4 | 648 | 64 | 647 | 65 | 650 | 128 | 648 | 123 | no change | ⊚ | ⊚ | ⊚ | ⊚ | ⊚ |
| Ex. 5 | 644 | 62 | 644 | 64 | 645 | 120 | 635 | 118 | no change | ⊚ | ⊚ | ⊚ | ⊚ | ⊚ |
| Ex. 6 | 651 | 64 | 650 | 66 | 653 | 132 | 655 | 140 | no change | ⊚ | ⊚ | ⊚ | ⊚ | ⊚ |
| Ex. 7 | 655 | 68 | 650 | 60 | 656 | 158 | 656 | 161 | no change | ⊚ | ⊚ | ⊚ | ⊚ | ⊚ |
| Ex. 8 | 641 | 60 | 632 | 59 | 642 | 118 | 642 | 120 | no change | ⊚ | ⊚ | ⊚ | ⊚ | ⊚ |
| Ex. 9 | 642 | 58 | 638 | 51 | 644 | 115 | 645 | 110 | no change | ⊚ | ⊚ | ⊚ | ⊚ | ⊚ |
| Co. Ex. 1 | 648 | 60 | 644 | 58 | 649 | 120 | 550 | 95 | no change | ⊚ | ⊚ | X | ⊚ | X |
| Co. Ex. 2 | 652 | 88 | 656 | 85 | 653 | 205 | 660 | 235 | no change | ⊚ | X | ⊚ | X | X |
| Co. Ex. 3 | 640 | 61 | 639 | 58 | 644 | 116 | 565 | 105 | no change | ⊚ | ⊚ | X | ⊚ | X |
| Co. Ex. 4 | 650 | 64 | 650 | 66 | 652 | 168 | 659 | 201 | no change | ⊚ | ◯ | ⊚ | X | X |
| Co. Ex. 5 | 638 | 60 | 638 | 55 | 645 | 118 | 551 | 101 | no change | ⊚ | ⊚ | X | ⊚ | X |
| Co. Ex. 6 | 647 | 61 | 650 | 63 | 650 | 165 | 658 | 211 | no change | ⊚ | ◯ | ⊚ | X | X |
| Ex. 10 | 652 | 68 | 655 | 66 | 655 | 150 | 611 | 140 | no change | ⊚ | ⊚ | ◯ | ⊚ | ◯ |
| Ex. 11 | 655 | 77 | 659 | 82 | 659 | 172 | 665 | 180 | no change | ⊚ | ◯ | ⊚ | ◯ | ◯ |
| Ex. 12 | 635 | 55 | 625 | 50 | 640 | 112 | 638 | 110 | precipitation | ⊚ | ⊚ | ⊚ | ⊚ | ◯ |
| Ex. 13 | 642 | 78 | 648 | 77 | 645 | 159 | 660 | 145 | no change | ⊚ | ⊚ | ⊚ | ⊚ | ◯ |

Ex.: Example, Co. Ex.: Comparative Example

The following facts are found from the results shown in Table 2.

(1) The photoreceptors of Examples 1 to 9 respectively contain the titanium oxide [P] constituted of the needle-like titanium oxide [A] and the spherical titanium oxide [B] and the binder resin [R], wherein the compounding ratio (by weight) [A]/[B] is 60/40 to 90/10 and the binder resin [R] is an alcohol-soluble polyamide. Each of these photoreceptors exhibits good characteristics as the photoreceptor and excellent repetitive stability in various environments and also has high storage stability of the coating solution and good image characteristics.

(2) A reduction in the V0 of the photoreceptor containing no spherical titanium oxide [B] according to Comparative Example 1 after the 100,000-time-fatigue test in the surface potential under the L/L circumstance is very large and the fogging after the 100,000-time-fatigue test is considerably impaired in image characteristics.

(3) The VL of the photoreceptor containing no needle-like titanium oxide [A] according to Comparative Example 2 in the initial stage in the surface potential under the L/L circumstance is very high and this photoreceptor has a problem concerning image density in the initial stage and after the 100,000-time-fatigue test in its image characteristics.

(4) The photoreceptors obtained in Comparative Examples 3 and 5 in which the compounding ratio (by weight) [A]/[B] of the titanium oxide [P] is larger than 90/10 have large reduction of V0 after the 100,000-time-fatigue test in the surface potential under the L/L circumstance and the fogging after the 100,000-time-fatigue test is considerably impaired in image characteristics.

(5) The photoreceptors obtained in Comparative Examples 4 and 6 in which the compounding ratio (by weight) [A]/[B] of the titanium oxide [P] is smaller than 60/40 have a very high VL in the initial stage in the surface potential under the L/L circumstance and also have a problem concerning image density after the 100,000-time-fatigue test in image characteristics.

(6) The photoreceptor obtained in Example 10 in which the primary particle diameter of the spherical titanium oxide [B] is larger than 0.05 μm has large reduction of V0 after the 100,000-time-fatigue test in the surface potential under the L/L circumstance and has more deteriorated fogging after the 100,000-time-fatigue test in image characteristics than those obtained in Examples 1 to 9: however, the deterioration is on no-problematic level in practical use.

(7) The photoreceptor obtained in Example 11 in which the compounding ratio [P]/[R] of the titanium oxide [P] to the binder resin [R] is smaller than 30/70 has a very high VL in the initial stage in the surface potential under the L/L circumstance and has more deteriorated fogging in the initial stage and after the 100,000-time-fatigue test in image characteristics than those obtained in Examples 1 to 9: however, the deterioration is on no-problematic level in practical use.

(8) The photoreceptor obtained in Example 12 in which the compounding ratio [P]/[R] of the titanium oxide [P] to the binder resin [R] is larger than 30/70 has deteriorated storage stability of the coating solution and produces precipitates when it is allowed to stand for one week though it has no particular problem concerning surface potential and image characteristics.

(9) The photoreceptor obtained in Example 13 in which the binder resin [R] is not an alcohol-soluble polyamide but is a butyral resin has no particular problem concerning surface potential and image characteristics. However, when the charge generation layer is formed by dipping coating, the undercoat layer is slightly dissolved in the solvent used for the charge generation layer coating solution, leading to the generation of sagging and unevenness on the coating film of the charge generation layer and also, causing image unevenness originated from the coating unevenness.

1) Packaging suitable for heating in the microwave, oven, or water bath consisting of a multi-layered film material having at least one area which becomes permeable when the internal pressure produced by the microwave heating is exceeded characterized by this area being produced by a microperforation covered by a label, hot stamping film, or a varnish coating.

2) Packaging in accordance with claim 1 characterized by the microperforated area having, for example, the shape of a circle, rectangle, square, trapezoid, triangle, an ellipsis or semi-ellipsis, but also the shape of specific marks, symbols, letters, text, and the like.

3) Packaging in accordance with one of claims 1 or 2 characterized by the microperforation being shaped like a circle, a slit, a rectangle, a square, and the like.

4) Packaging in accordance with one of claims 1 to 2 characterized by the microperforation being shaped like a logo.

5) Packaging in accordance with one of claims 1 or 2 characterized by the microperforated area having a varnish coating based on a mixture or a polyester acrylate, or epoxyacrylate colophonium, acrylate, alkyde, melamine, PVA, PVC, isocynate, urethane systems, butadiene, a styrene system, or their copolymers.

6) Packaging in accordance with claim 3 characterized by the varnish coating, the label, or the hot stamping film containing an energy-absorbing additive.

7) Packaging in accordance with one of claims 1 to 4 characterized by intermediate layers being provided between the external and internal layers.

8) Packaging in accordance with claim 5 characterized by the intermediate layers being barrier layers, absorber layers, browning layers, flexibility, or strength, or rigidity, and/or printed layers.

9) Packaging in accordance with one of claims 1 to 6 characterized by the side of the interior layer facing the interior space of the packaging having an absorber layer which is fixed in place by a membrane with a rupture site.

10) Packaging in accordance with one of claims 1 to 7 characterized by different markings being applied to the area of the microperforation which show a definite change in the optical image after the valve is opened.

11) Film material for the manufacture of packagings in accordance with one of claims 1 to 8.
